(19) United States
(12) Patent Application Publication
(10) Pub. No.: US 2013/0270448 A1
(43) Pub. Date: Oct. 17, 2013

(54) RADIATION IMAGE ACQUISITION DEVICE, AND IMAGE PROCESSING METHOD

(71) Applicants: Takafumi Ishitsu, Hitachi (JP); Takatoshi Maruyama, Kashiwa (JP); Katsutoshi Tsuchiya, Hitachi (JP); Yuichiro Ueno, Hitachi (JP)

(72) Inventors: Takafumi Ishitsu, Hitachi (JP); Takatoshi Maruyama, Kashiwa (JP); Katsutoshi Tsuchiya, Hitachi (JP); Yuichiro Ueno, Hitachi (JP)

(73) Assignee: HITACHI, LTD., Tokyo (JP)

(21) Appl. No.: 13/976,563

(22) PCT Filed: Dec. 27, 2011
(86) PCT No.: PCT/JP2011/080177

§ 371 Date: Jun. 27, 2013

(30) Foreign Application Priority Data
Dec. 28, 2010 (JP) 2010-291596

(51) Int. Cl. G06T 5/00; G01T 1/16

(52) U.S. Cl. CPC G06T 5/002; G01T 1/16
USPC 250/394; 382/132

(57) ABSTRACT

An image processing device of a radiation image acquisition device (100) uses a weighted filter to perform a smoothing (processing S102) on an image obtained by counting the number of incident gamma rays. The image processing device suppresses pixel values of a threshold value or less on the smoothed image (processing S103). Further, the image processing device again applies a weighted and smoothing filter to the image processed by a threshold-value processing, to expand the pixels of the accumulation portion (processing S104); thus providing an image that facilitates finding the accumulation portion of a radioisotope.

### TECHNICAL FIELD

The invention relates to a radiation image acquisition device, and an image processing method for acquiring and making a distribution of incident radiation image of radiation emitted from a radioactive material. In particular, the invention relates to a radiation image acquisition device and an image processing method for identifying an accumulation position of a radioactive pharmaceutical.

### BACKGROUND ART

A radiation image acquisition device such as a gamma camera, a SPECT (Single Photon Emission Computed Tomography) system and a PET (Positron Emission Tomography) system make it possible to detect a distribution of a radioactive material non-invasively. By use of this aspect, as is a sentinel lymph-node biopsy in a surgery of breast cancer using a RI (radioisotope) method, a small-sized gamma camera (for example, Patent Document 1) is used to try to simply realize the RI accumulation position in the body to identify the portion to be cut. Use of the small-sized gamma camera enables identification of the position of the sentinel lymph-node to be extracted before the surgery, thereby achieving shortened surgery time or the like.

An image acquired by the gamma camera contains a lot of noise. To reduce the noise, a Gauss filter, a median filter or a threshold filter as described in Patent Document 2 is used to reduce the noise.

### PRIOR ART DOCUMENT

### Patent Document

Patent Document 1: Patent Application Publication Laid-Open No. 2001-324569

Patent Document 2: Patent Application Publication Laid-Open No. 2002-183709

### SUMMARY OF INVENTION

### Problem to be Solved by the Invention

When using RI for identification of a sentinel lymph-node or the like, if it is just after an injection of the RI, an intensity of the RI is sufficiently high and a count rate per pixel is high enough, making it possible to obtain a clear image even with a short imaging duration. However, it is usually the case that identification of a sentinel lymph-node or the like uses a method of acquiring an image at a certain time after administration of the RI to avoid false detection. This method attenuates a concentration of the RI, and lowers a count rate detected by an image acquisition device. Therefore, a long imaging duration is necessary to clearly capture a distribution of the RI.

On the other hand, the position of a sentinel lymph-node is displaced depending on change of a patient's posture. Therefore, the image acquisition is desirably performed after a patient is placed on an operating table. The image acquisition is performed immediately before an operation or during the operation, and it is difficult to ensure a sufficient time duration. The low intensity of the RI and a short image acquisition time cause the count number of the image acquired to become small, which makes it difficult to identify the accumulation portion of the RI.

In an actual identification of a sentinel lymph-node, the position of the gamma camera is changed to find a sentinel lymph-node. Therefore, an image acquisition per time is a few seconds to a few tens of seconds. Therefore, signals originating from the RI are occasionally taken by only 1 or 2 counts of gamma rays per pixel. On the other hand, under the influence of cosmic rays and background radioactive rays from the RI which is distributed at a portion other than the sentinel lymph-node in a patient's body, gamma rays to be observed as noise at portions other than the accumulation portion. There are a number of pixels having the same levels as those of the signals from the RI, which makes it difficult to identify the accumulation portion by a count number per pixel.

A method for reducing noise uses a weighted filter, represented by a Gauss filter, and a nonlinear filter such as a median filter for the image obtained. However, the weighted filter blurs an image to suppress the noise, and cannot remove the background radioactive rays of a low count number. When the count number of true signals is very small, the median filter suppresses not only the background but also the true signals.

Another Patent Document 2 shows a method for suppressing data having a count of the threshold value or less. However, if the method is applied to an image having a count number of no more than a few counts, the method suppresses the true signals, and fails to serve an effect.

The invention solves the problem, and is directed to a radiation image acquisition device, and an image processing method, which appropriately processes an image of a low count number, thereby facilitating finding the accumulation portion of a radioisotope.

### Means for Solving Problem

To achieve the object, a radiation image acquisition device of the present invention applies a low-pass filter using a weighted filter to an acquired image, thereafter suppressing a value of a pixel having a count number of a threshold value or less, applying a second low-pass filter again to an image processed by the threshold processing to emphasize a pixel having a value of the threshold value or more, and thereby providing an image which easily indentifies an accumulation position.

The threshold value of the image depends on the count number caused by noise. A method for estimating a count number caused by the noise includes a method of previously estimating a value depending on an image acquisition time, in addition, a method of calculating a value from an actual image acquisition time and an estimated count rate of the noise, and a method of estimating a value from an image created by an energy window separately provided.

### Advatageous Effects of the Invention

According to the invention, appropriate processing of an image of a low count number facilitates finding an accumulation portion of a radioisotope.

### BRIEF DESCRIPTION OF DRAWINGS

FIG. 1 is a view generally showing a radiation image acquisition device according to an embodiment of the present invention.

FIG. 2 is a view showing processing blocks of an accumulation and display console according to the embodiment of the present invention.

FIG. 3 is a view showing a distribution of energy in a radiation image acquisition device.

FIG. 4 is a view showing a flow of a filtering in a radiation image acquisition device.

FIGS. 5A to 5D are views showing examples of images on a radiation image acquisition device, respectively; FIG. 5A is an image in the processing S101; FIG. 5B is an image in the processing S102; FIG. 5C is an image in the processing S103; and FIG. 5D is an image in the processing S104.

FIGS. 6A, 6B and 6C are views showing the principle of a weighted filter of N×N; FIG. 6A is a view showing a situation in which a filter of 3×3 (hatched portion) is applied to an image; FIG. 6B is a view showing a group of input pixels at calculation; and FIG. 6C is a view showing weights of the filter.

### EMBODIMENT FOR CARRYING OUT THE INVENTION

The specific descriptions will be given of an embodiment of the present invention with referring to the drawings.

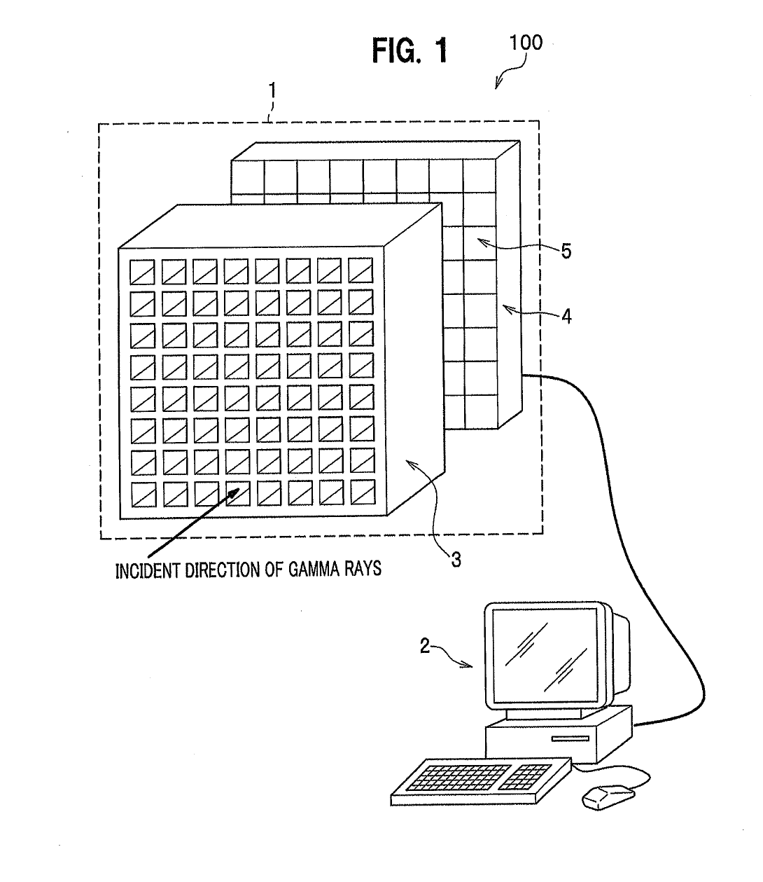

FIG. 1 is a general view showing a radiation image acquisition device 100 according to an embodiment of the present invention. The description is given of a small-sized gamma camera 1 serving as a nuclear medical diagnosis device with reference to FIG. 1.

The radiation image acquisition device 100 is consisted of a gamma camera 1, and a collection and display console (image processing device) 2. The collection and display console 2 performs start or stop of image collection, based on an operation by a user. The below description will be given of a function of the collection and display console 2.

The gamma camera 1 includes a collimator 3 and a detector panel 4. The collimator 3 has a material such as lead or tungsten which is excellent for shielding gamma rays and defines a large number of holes therethrough. The collimator 3 has gamma rays traveling in a specified direction transmit therethrough. The gamma rays, after transmitting through the collimator 3, travel to a detector panel 4. The detector panel 4 includes detector pixels 5, which detect the gamma rays.

The detector pixels 5 use, for example, a CZT (Cadmium Zinc Telluride) or a CdTe (Cadmium Telluride) which is a semiconductor detector, and a structure is considered in such a way that a single pixel corresponds to a single detector. For another example, signals from a large-sized detector such as an Anger-type gamma camera (see U.S. Pat. No. 3,011,057), are processed by a signal processing to have the positions detected, and the position signals are digitized to be divided into pixels. When detecting gamma rays, the detector pixels 5 measure the energy of the gamma rays to be outputted. The detector panel 4 sends the collection and display console 2 the positions of the detector pixels 5, which detect gamma rays, and the energy of the gamma rays.

The collection and display console 2 creates an image, based on a set of data that is sent from the gamma camera 1.

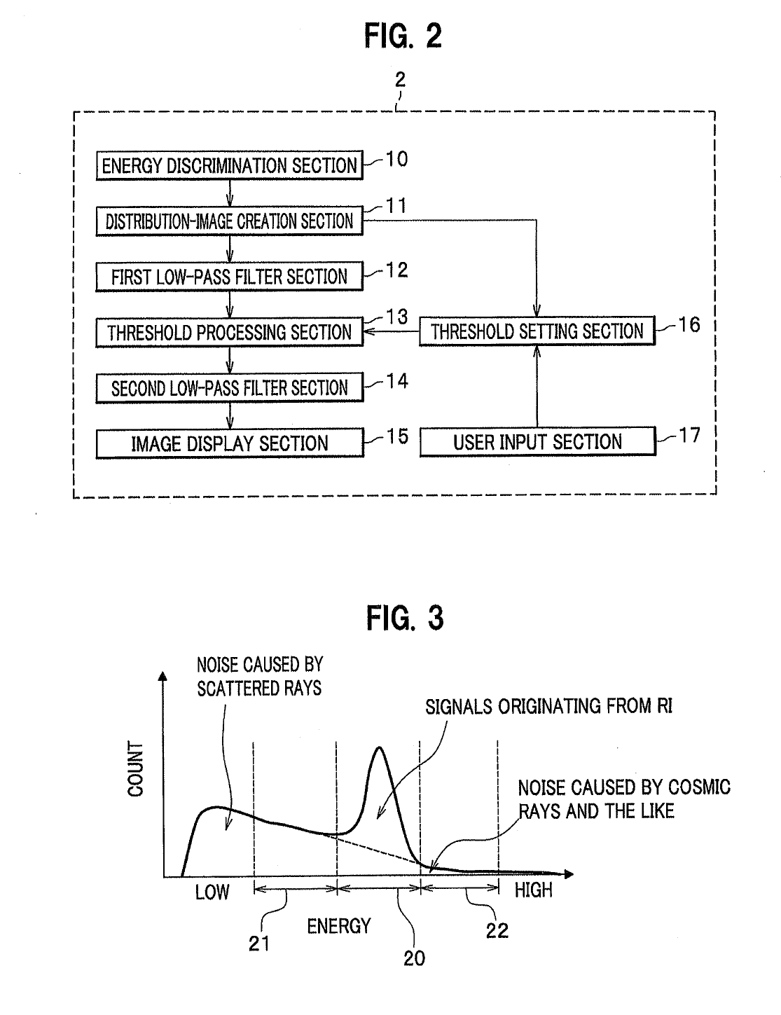

FIG. 2 is a view showing processing blocks of the collection and display console 2 according to the embodiment of the present invention. The collection and display console 2 includes an energy discrimination section 10, a distribution-image creation section 11 (distribution-image creation means), a first low-pass filter section 12 (first filtering means), a threshold processing section 13 (second filtering means), a second low-pass filter section 14 (third filtering means), an image display section 15, a threshold setting section 16 connected to the distribution-image creation section 11, and a user input section 17.

In the collection and display console 2, firstly, the energy discrimination section 10 decides if a set of data sent, which is based on the energy of gamma rays, originates from a collected RI. The histogram of the detected energy is like that of FIG. 3, having signals from the RI and other various noises superposed on each other. The noise is caused by cosmic rays, scattered gamma rays and the like. An effect of environmental radioactive rays such as cosmic rays is kept almost uniform as energy.

The scattered gamma rays are caused by the gamma rays which are emitted from the RI and are scattered in a patient's body. The scattered gamma rays have lost energy when being scattered, and are distributed to an energy position lower than the original energy position. The scattered rays are generated by true signals originating from the RI. The directions of the gamma rays are changed when the gamma rays are scattered, and the scattered rays occasionally lose information of the collected positions of the RI. The signal is treated as noise in the image. Therefore, the energy discrimination section 10 distinguishingly counts only a set of data having energy included in the energy window 20 for RI (see FIG. 3), thereby reducing noise.

Only a set of data of the energy window 21 for scattered rays or the energy window 22 for cosmic rays is used for obtaining an image caused by noise. The image is able to be used for correction of the image.

Next, the distribution-image creation section 11 creates an image showing the distribution of the RI. A set of data, sent from the gamma camera 1, records the positions where gamma rays are detected. Therefore, counting the number of data at each position enables the distribution-image of the RI to be obtained.

The first low-pass filter section 12 applies a low-pass filter to the image which is created by the distribution-image creation section 11. Use of the low-pass filter degrades a spatial resolution, and, on the other hand, enables the noise on the image to be suppressed. This low-pass filter is specifically described below.

The threshold processing section 13 applies a threshold filtering to the image created by the first low-pass filter section 12, based on the threshold value indicated by the threshold setting section 16. If a pixel value of each pixel on the image is greater than the threshold value, the pixel value is left as it is. If a pixel value of each pixel on the image is the threshold value or less, the pixel value is suppressed.

The second low-pass filter section 14 applies a low-pass filter to an image processed by the threshold processing section 13 again. The filtering is intended for enlarging the width of the region, and uses a weighted filter, for example, which has a weight of 1 assigned to all pixels of 3×3.

The image display section 15 displays an image created by the second low-pass filter section 14.

The threshold setting section 16 sets a threshold value, based on the image created by the distribution-image creation section 11 and the parameters indicated by the user input section 17. If the threshold value set by the threshold setting section 16 is too large, signals from the RI cannot be detected. If the threshold value is too small, a count caused by noise makes a false decision. Therefore, it is important to set an appropriate threshold value. To prevent accumulation of the RI from being falsely decided, the threshold value is desirably set in such a way that the false detection caused by noise is at sufficiently less than a single pixel in a whole visual field.

Determination of the threshold value is required to know the count number caused by noise. In the decision on accumulation of the RI with the small-sized gamma camera 1, a dose of the RI is given by approximately a predetermined amount which is determined by the examination, and an intensity of the RI is approximately the same as one in each examination. A time useable for decision in an acquisition time is limited to fall within a range of a few tens of seconds to a few tens of minutes. Therefore, it is made possible to estimate a count number of signals from the RI and the noise which are measured by the gamma camera 1.

To be specific, the threshold setting section 16 (threshold setting means) determines a threshold value of a pixel value by the count number of noise which is found by multiplying a count rate of noise that are estimated depending on an acquisition time of an image; by the acquisition time.

In a method of directly measuring the count number of noise, if the gamma camera 1 has sufficiently large visual field and the accumulation portion of a RI is small, the count number originating from the signals (gamma rays) generated from the RI is deemed to be sufficiently smaller than the count number caused by noise. The total count number by all the detector pixels 5 (whole detector) of the gamma camera 1 is enabled to be deemed to be the count number caused by the noise.

In another one, when energy is distinguished, the energy window 21 for scattered gamma rays (see FIG. 3) and the energy window 22 for cosmic rays (see FIG. 3) are used to create an image other than the image by signals originating from the RI. The created image is used to find the count number caused by noise. That is, the distribution-image creation section 11 (distribution-image creation means) creates an image for calculating a threshold value for the distribution of radioactive rays by use of an energy window different from the energy window at acquiring of the image. The threshold setting section 16 (threshold setting section) determines a threshold value of a pixel value, based on the count number on the image for calculating the threshold value.

It is possible to easily find an expected value of the count number per pixel caused by noise from the count number of noise of the whole gamma camera 1. If the expected value of the count number is found, a probability of counting a predetermined value at each pixel is able to be calculated from the Poisson distribution. Once a filter coefficient is determined, it is possible to calculate a probability distribution of the count numbers on the pixels filtered by the first low-pass filter from a probability distribution of ones on the non-filtered pixels. In the threshold processing, when a threshold value is given, it is possible to find a probability of exceeding the threshold value by noise. On the contrary, it is possible to determine a threshold value, which is necessary for a probability of not exceeding the threshold value by noise to be at a predetermined value or less.

This way finds a probability distribution of the count number of noise after the first low-pass filtering, and determines a threshold value for sufficiently lowering a probability of exceeding the threshold value, which enables a false detection caused by noise to be avoided.

A user inputs a probability of false detection caused by noise or directly inputs a threshold value to the user input section 17 to determine the threshold value.

Next, the description is given of the hardware configuration of the collection and display console 2.

The collection and display console 2, as not shown in the figures, includes a processor (processing section), a memory (memory section), an input device corresponding to the user input section 17, and an output device corresponding to the image display section 15. The collection and display console 2 connects to an external memory device via a disk interface. The processor is configured with, for example, a CPU (Central Processing Unit). The processor executes a processing program for each section (for example, the energy discrimination section 10) to perform a processing of each means.

The processing program of each section is executed by the processor to be realized. On the other hand, a processing section of each section may be configured with an integrated circuit for realizing with hardware.

The memory is configured with a memory media such as a RAM (Random Access Memory) and a flash memory. The input device is configured with a device such as a keyboard and a mouse. The output device is configured with a device such as a liquid crystal monitor. The processing data of each section as described above (for example, image data) are normally stored in an external memory device, and is stored in a memory depending on the necessity.

Next, the description is given of a processing of each section with reference to an example of an image.

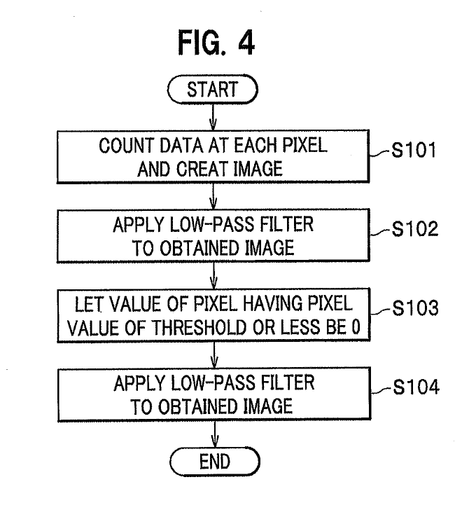

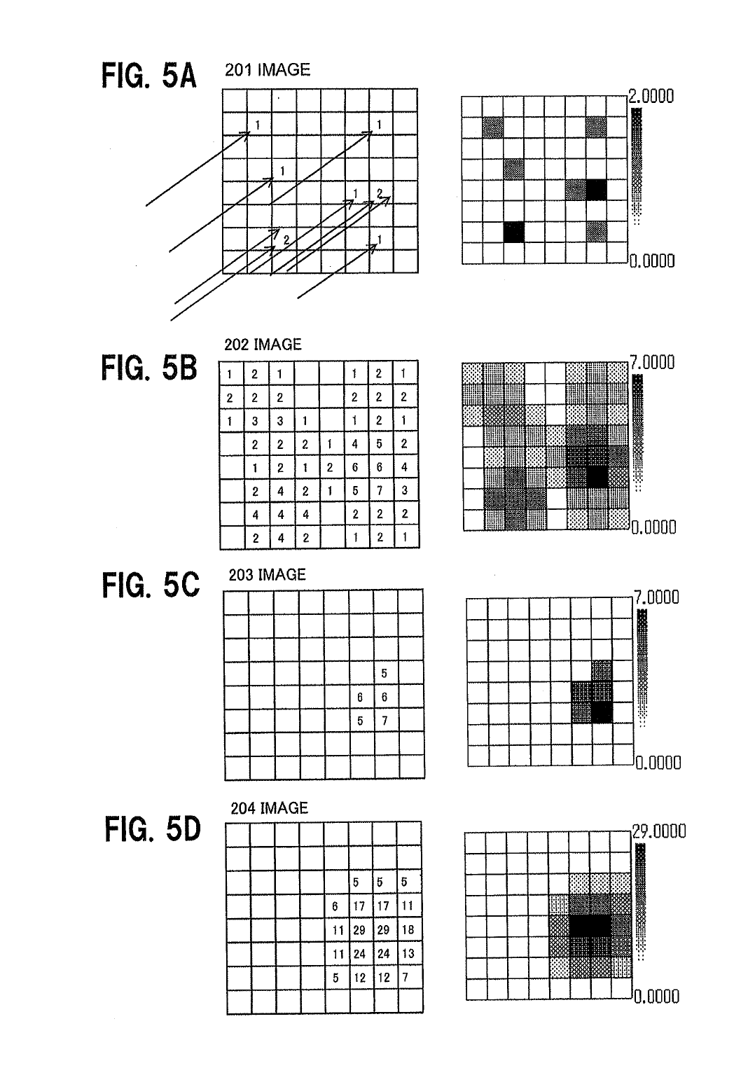

FIG. 4 is a view showing a flow of a filtering of the radiation image acquisition device 100. FIGS. 5A to 5D are views showing examples of images on the radiation image acquisition device 100, respectively. FIG. 5A is an image 201 in the processing S101. FIG. 5B is an image 202 in the processing S102. FIG. 5C is an image 203 in the processing S103. FIG. 5D is an image 204 in the processing S104. In the processing S101, the distribution-image creation section 11 counts the number of the data selected at each pixel to create an image. In the image creation, a user operates the collection and display console 2 to have the count numbers added from the start point of the collection.

The processing S101 obtains an image 201 as shown in FIG. 5A. The left side shows the count number at each pixel (each detector pixel 5). The right side is an example of an image showing the count number with thick and thin shades. The present embodiment shows an example of 8×8 pixels. In practice, the embodiment uses a camera having pixel pitches of about 1 mm to 2 mm and a visual field size having pixels of about 30×30 to about 100×100. Though depending on a collection time, the count number caused by noise is an average of about 0.01 counts per pixel, and the count number of the signals (gamma rays) originating from a RI is an average of about 1 count. Even if the accumulation of the RI is decided with 1 count or more, a camera having, for example, the pixel number of 100×100 produces, on the whole camera, 100 pixels which records 1 count or more caused by noise, and the pixels having 2 counts or more at about a half of the probability, thereby failing to decide the accumulation by the threshold value based on the count number.

In the processing S102, the first low-pass filter section 12 applies the low-pass filter to the image obtained. The low-pass filter is a weighted filter of 3×3 pixel number, and performs smoothing on pixels with a weight of 2 assigned to the center and the neighboring pixels, and a weight of 1 assigned to the pixels in oblique directions.

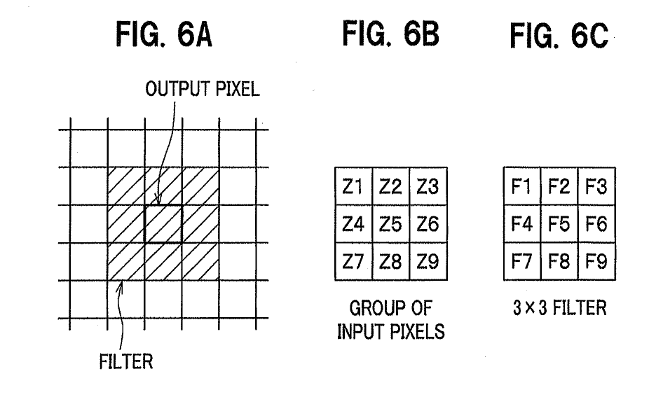

FIGS. 6A to 6C are views showing a principle of a weighted filter of N×N. Herein, letting N be 3 (N=3), the description will be given of the weighted filter of 3×3. FIG. 6A shows a situation in which a filter of 3×3 (hatched portion) is applied to an image, and the center of the filter is an output pixel for a calculation object. FIG. 6B is a group of input pixels at calculation. FIG. 6C shows a weight of the filter. The output pixel (Z5) corresponding to the center of the filter as shown in FIG. 6B has a Z value, which is calculated in accordance with the following equation.

Z=(Z1F1)+(Z2×F2)+(Z3×F3)+ . . . +(Z9×F9)

For example, if Z5 of the central pixel in FIG. 6B, is 1 and ones of the other pixels are 0, the filter of 3×3 is applied in FIG. 6C, with the central and the neighboring pixels each having a weight of 2, and the oblique pixels each having a weight of 1. This gives F1=F3=F7=F9=1 and F2=F4=F5=F6=F8=2, and the calculation results in Z=2.

Though the present embodiment uses the 3×3 filter, the embodiment may use a 5×5 filter or a weighted filter of a larger extent.

The embodiment may use a filter having a weight of a Gaussian function or other value mathematically defined.

The processing S102 obtains an image 202 as shown in FIG. 5B. Only use of the low-pass filter causes the image to be blurred, and fails to separate the signals caused by accumulation of the RI and noise.

In the processing S103, the threshold processing section 13 performs the threshold processing to the image which results from the processing S102, letting pixels of the threshold value or less be at a value of 0, respectively. This processing obtains an image 203 as shown in FIG. 5C. The first combination of the filter processing and the threshold processing enables the accumulation portion to be identified.

The threshold value for eliminating false counting caused by noise is determined by the average count number of noise during the measurement. For example, if an average count number is assumed to be 0.01, the calculation is capable of finding a probability that a pixel value exceeds the threshold value after application of the low-pass filter in the processing S102. The probability that a pixel value exceeds 4 is about 2.5×10⁻³. The probability that a pixel value exceeds 5 is about 2.2×10⁻⁴. The probability that a pixel value exceeds 6 is about 1.2×10⁻⁴. In consideration of a camera constructed with pixels of 100×100, the numbers of the pixels, each of which is caused by noise to have a pixel value exceeding the threshold value, are 25 pixels, 2.2 pixels and 1.2 pixels on the average, respectively. If the threshold value is 5 or less, false detection caused by noise is controlled at about 1 pixel.

Accumulation of the RI normally has a size of a few millimeters, and signals from the collected RI have a correlation between count numbers of the pixels. On the other hand, a count caused by noise has a small correlation between the pixels. Therefore, threshold processing after application of the low-pass filter enables only the signals from the RI, having a correlation between the pixels, to be extracted.

A collection time is easily measureable. This measurement enables determination of the threshold value by a method for calculating an average count of noise from an average rate of estimated noise, or by creating another image with an energy window including no signals to calculate an average count based on the count number. It is considered that input from a user determines a threshold value.

The threshold processing decides whether a value of a pixel is over a threshold value. If the threshold processing is processed by a calculator, the processing becomes slow. The image display is required to be performed in real time. As the simplest method of lightening the processing is considered in such a way that a coefficient of the weighted filter performed on the processing S102 exceeds a value of 1 or less inclusive of a decimal point, and the threshold processing truncates the decimal point from the coefficient. When the decimal point is truncated, lower count numbers do not have a linearity between input and output count numbers. On the other hand, the lower count numbers are sufficient to confirm the presence or absence of an accumulation, thereby realizing a high-speed threshold processing.

In the processing S104, the second low-pass filter 14 applies a low-pass filter to the image resulted from the processing S103 again. According to the embodiment, the filter of 3×3 having a weight of 1 is applied to all the pixels to be expanded, thereby emphasizing the accumulation portion. This enables the accumulation portion to be largely displayed on the image, and facilitate finding the accumulation of the signals from the RI. It is noted that a filter coefficient is not limited to this.

The processing result obtains the image 204 as shown in FIG. 5. Thus, the low-pass filter and an appropriate threshold value are used to enable the accumulation position of the RI to be identified.

According to the present embodiment, the collection and display console 2 (image processing device) of the radiation image acquisition device 100 counts an incident number of gamma rays to obtain an image, and performs smoothing to the obtained image using the weighted filter (processing S102). The image processing device suppresses pixel values of the threshold value or less on the smoothed image (processing S103). The image processing device applies the weighted and smoothing filter to the image processed by the threshold processing again to expand the pixels of the accumulation portion (processing S104). This processing provides an image which facilitates finding the accumulation portion of a radioisotope.

According to the embodiment, the emphatic display of only the accumulation positions of a radiopharmaceutical on a radiation image having low count numbers, enables the accumulation position of the pharmaceutical to be identified for a short time. This shortens a time necessary for an operation or a diagnose, and reduces patient strain.

The embodiment mainly describes a radiation image acquisition device for a medical treatment. On the other hand, it is applicable for a field such as a nuclear security which decides with an image having a small count number.

### DESCRIPTION OF REFERENCE NUMERALS

1 gamma camera
2 collect and display console (image processing device)
3 collimator
4 detector panel
5 detector pixel
10 energy discrimination section
11 distribution-image creation section (distribution-image creation means)
12 first low-pass filter section (first filtering means)
13 threshold processing section (second filtering means)
14 second low-pass filter section (third filtering means)
15 image display section
16 threshold setting section
17 user input section
20 energy window for RI
21 energy window for scattered rays
22 energy window for cosmic rays
100 radiation image acquisition device

1. A radiation image acquisition device comprising:
a distribution-image creation means configured to create an image of a distribution of radioactive rays detected;
a first filtering means configured to perform a first low-pass filtering to the image created; and
a second filtering means configured to suppress pixel values of a threshold value or less, the pixel values being of respective pixels on the image obtained by the processing of the first filtering means.

2. The radiation image acquisition device according to claim 1, further comprising a third filtering means configured to again perform a second low-pass filtering to the image obtained by the processing of the second filtering means.

3. The radiation image acquisition device according to claim 1, further comprising a threshold setting means,
wherein the threshold setting means determines the threshold value for the pixel value, based on a count number of noise which is found by multiplying a count rate of the noise estimated depending on an acquisition time of the image; by the acquisition time.

4. The radiation image acquisition device according to claim 1, further comprises a threshold setting means,
wherein the distribution-image creating means creates an image for threshold calculation of a distribution of the radioactive rays using an energy window different from an energy window during acquiring of the image,
wherein the threshold setting means determines the threshold value for the pixel value, based on a count number on the image for threshold calculation.

5. An image processing method for an image processing device which processes an image of a distribution of radioactive rays detected by a detector panel,
the image processing device:
creating an image of a distribution of radioactive rays detected;
performing a first filtering which applies a first low-pass filtering to the created image; and
performing a second filtering which suppresses pixel values of a threshold value or less, the pixel values being of respective pixels on the image obtained by the first filtering.

6. The image processing method according to claim 5, the image processing device further performing a third filtering which performs a second low-pass filtering to an image obtained by the second filtering.

7. The image processing method according to claim 5, the image processing device determining a threshold value for the pixel value, based on a count number of noise that is calculated by multiplying a count rate of the noise estimated depending on an acquisition time of the image; by the acquisition time.

8. The image processing method according to claim 5,
the image processing device:
creating an image for threshold calculation of a distribution of the radioactive rays by use of an energy window different from an energy window used in the acquisition of image; and
determining the threshold value for the pixel value, based on the count number of the image for threshold calculation.
